(19) United States
(12) Patent Application Publication
(10) Pub. No.: US 2004/0183384 A1
(43) Pub. Date: Sep. 23, 2004

(54) Noise reduced electric power conversion device

(76) Inventors: Jijin Wang, Zhaoqing (CN); Wenguang Wang, Zhaoqing (CN); Yaodong Yan, Zhaoqing (CN); Jun Li, Zhaoqing (CN)

Correspondence Address: HUSCH & EPPENBERGER, LLC, 190 CARONDELET PLAZA, SUITE 600, ST. LOUIS, MO, 63105-3441, US

(21) Appl. No.: 10/804,734

(22) Filed: Mar. 19, 2004

(30) Foreign Application Priority Data
Mar. 20, 2003 (CN) CN 03113957.4

(51) Int. Cl. H02K 5/24; H02K 1/00

(52) U.S. Cl. 310/51; 310/233

(57) ABSTRACT

A method of reducing the audible operating noise of an electric power conversion device includes providing a segmented commutator with slots between the segments and smoothing the brush transition between the slots to reduce brush vibration and the associated noise ordinarily created when the motor brush contacts the commutator. The commutator and assemblies for smoothing the commutator surface are disclosed.

### BACKGROUND OF INVENTION

The invention relates to electric power conversion devices which utilize spring loaded brushes contacting a rotating segmented or slotted commutator for the purpose of electrical routing or switching of voltage to or from its rotating armature and, more specifically, to the reduction of audible and electronic noise resulting from the operation of such systems.

Electric power conversion devices such as AC and DC motors commonly utilize a segmented or slotted commutator on a rotating central armature for electrical routing or switching as part of normal motor operation. This function maintains mechanical power output from a motor by continually switching the applied voltage to the armature windings that are best positioned relative to the motor magnets to produce output torque. The switching function optimizes the power output of the rotating armature. Electrical connection to the rotating armature having a segmented or slotted commutator is generally provided by spring loaded electrically conductive brushes which are usually constructed of a material having a high carbon content. The brushes are mechanically oriented to provide the optimum phase relationship between the various components of the motor or generator.

The interaction of the brushes against the segmented or slotted commutator is typically one of the major sources of both audible and electronic operating noise of electrical power conversion devices. The audible noise results from mechanical vibration as the brushes encounter the leading edges of the slots between commutator segments as the armature rotates. The electronic noise, known as Radio Frequency Interference, or RFI, is primarily caused by the electrical arcing at the commutator surface. The mechanical interaction of the brushes with the commutator slots as the armature rotates promotes this electrical arcing.

There are performance standards and requirements in most industries that utilize power conversion devices such as electric motors to reduce both the audible and electronic noise outputs of these devices. For example, in the automotive industry, General Motors applies a specification referred to as “GMW 3100” to the D.C. motors in their vehicles on a worldwide basis. The suppression of RFI has typically resulted in the addition of electronic components that increase the size, weight, and manufacturing cost of such D.C. motors.

For reducing audible noise, typical efforts to date have focused on improving the interaction between brushes and commutator. This has included changing the hardness of the brush compound, usually to soften it, and providing more precise machining and polishing of the commutator surface. The number of armature poles, and therefore the number of commutator segments, can also be varied to affect the noise output level and frequency. The brush can also be slightly angled to the commutator slot, so that the entire length of the leading edge of the slot is not encountered all at one time by the brush. However, even with a precision commutator, improved brushes, and optimized number of poles, the continual brush encounter with the rotating commutator slots still remains the primary source of audible and RFI noise.

### SUMMARY OF INVENTION

The invention consists of a method for significantly reducing both the audible and electronic (RFI) noise of an electric power conversion device, which utilizes a segmented commutator. This is accomplished by eliminating the mechanical gap between the commutator slots, and thereby also eliminating, or at least drastically reducing, the brush interaction with the leading edges of the commutator slots, while maintaining the electrical isolation between commutator segments. This can be accomplished in numerous ways. Several example processes are described that can fill the commutator slot regions with a suitable insulating material such as a two part epoxy. Subsequent mechanical finishing operations on the commutator surface also serve to ensure that the filler material in the commutator slots is machined along with the segments to provide a smooth, continuous commutator surface with no discontinuities to contribute to brush vibration or electrical arcing, thereby decreasing the noise produced during routing.

The invention also covers various processes for the manufacturing of armatures with filled commutator slots. A molding process to fill the commutator slots is described, and several devices are described for the filling of the commutator slots of an armature having a segmented commutator. In addition, the finishing machining and polishing steps that complete the filled commutator processing are described below.

Test results have shown that by the addition of an insulating filler material to the commutator slots a reduction in audible noise ranging from three percent to twelve percent is obtainable with commutator type motors, depending on the particular design and application. Likewise, RFI tests conducted to the requirements of GMW 3100 have shown a significant reduction in RFI emissions of a given small DC motor design when its armature is modified with epoxy filled commutator slots.

Accordingly, the invention is, briefly a method of reducing the audible operating noise of an electric power conversion device. The method includes providing a segmented commutator with slots between the segments and smoothing the brush transition between the slots to reduce brush vibration and the associated noise ordinarily created when the motor brush contacts the commutator.

The invention is also, briefly a method of reducing the RFI electronic operating noise of an electric power conversion device including providing a segmented commutator with slots between the segments and smoothing the brush transition between the slots to reduce brush vibration and the associated electrical arcing.

The invention is still further, briefly, a noise reduced electric power conversion device having a commutator with segments separated by slots spaced around the external surface of the commutator. The slots are filled with an insulating material to thereby provide a smooth brush transition between the slots and brush of a motor during electric power conversion.

The invention is also, briefly an electric motor having a noise reduced electric power conversion device wherein the device includes a commutator having segments separated by slots spaced around the external surface of the commutator. The slots are filled with an insulating material to thereby provide a smooth brush transition between the slots and brushes of a motor during electric power conversion.

The invention is also, briefly an assembly for producing a noise reduced electric power conversion device, wherein the assembly includes a tight sleeve sized and shaped appropriately for receiving a commutator. The commutator has slots between segments on the outer surface of the commutator, and an extruder forces insulating filler material under pressure into the slots of the commutator.

The invention includes further, briefly, an assembly for producing a noise reduced electric power conversion device. The assembly includes a machining device having a cutting tool disposed in movable contact with the surface of a commutator having insulating material filled slots when an armature with such commutator is supported on the assembly. A drive device is included, and a V-block fixture to support the armature assembly by shaft ends of the armature assembly to allow the armature to rotate about its shaft axis when driven by the drive device. The cutting tool is movable parallel to the armature shaft axis so that the cutting tool lightly contacts the commutator to remove material and provide a smooth surface on the commutator segments, to thereby produce high precision motors with low operating noise relative to conventional motors without filled commutator slots.

These and other goals and advantages of the invention will be in part apparent and in part pointed out hereinbelow.

### BRIEF DESCRIPTION OF DRAWINGS

FIG. 1 is a schematic, longitudinal sectional view of a typical D.C. motor adapted in accordance with the present invention.

FIG. 1A is a cross-sectional view of the motor of FIG. 1.

FIG. 2 is a cross-sectional view of a typical segmented unfilled commutator.

FIG. 2A is a longitudinal sectional view of the commutator of FIG. 2.

FIG. 3 is a cross-sectional view of a segmented filled commutator in keeping with the present invention.

FIG. 3A is a longitudinal sectional view of the segmented filled commutator of FIG. 3.

FIG. 4 is a schematic illustration of equipment used to accomplish the new rotational manufacturing process for filling commutator slots in keeping with the present invention.

FIG. 4A is a partial end view taken from the direction of arrow 4A in FIG. 4.

FIG. 5 is a schematic side elevational illustration of equipment used to accomplish the extrusion manufacturing process for filling commutator slots in keeping with the present invention.

FIG. 6 is a schematic side view, partially in section, of equipment used in the commutator machining process of the present invention.

FIG. 7 is a graph illustrating the results of audible noise tests performed with unfilled commutators.

FIG. 7A is a graph illustrating the result of audible noise tests performed with commutators filled in keeping with the present invention and illustrating a clear reduction of noise as compared to the results shown in FIG. 7.

FIGS. 8A through 8H graphically illustrate comparative RFI results from tests performed at various MHz levels in both unfilled and filled commutators.

Throughout the drawings like parts are indicated by like element numbers.

### DETAILED DESCRIPTION

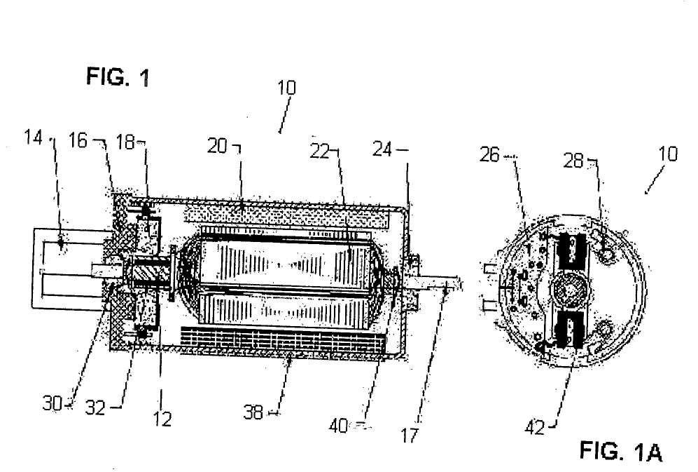

Referring to the drawings, FIG. 1 illustrates one practical embodiment of the invention as applied to a direct current (“DC”) motor, generally designated 10. A cutaway side view of DC electric motor 10 shows the relationship of the various components with respect to the commutator 12, which is filled in accordance with the present invention. An input terminal 14 to motor 10 is housed inside a connector shell. An endcap 16, which provides the mechanical support for motor shaft 17 and houses the electrical components of motor 10, including contact brushes 18. A motor brush 18 is sprung against the commutator 12 outer surface to provide the electrical input to armature 22 as the armature rotates. Permanent magnets 20 provide the magnetic field for armature 22 to react against. Motor armature 22 is sometimes referred to as the “rotor”, and consists of wire windings around steel laminated disks to provide a high magnetic field to react against the field from permanent magnets 20. The armature windings are energized by electrical connection through the brushes as the armature rotates. A support bushing 24 for the armature shaft 17. A circuit board assembly 26 is part of the endcap and can contain electronic components, usually for the purpose of RFI suppression. A spring element 28 provides the contact force of brush 18 against commutator 12. A spherical support bushing 30 for the other end of motor armature 22.

Insulating filler material, such as indicated at 32 is added into the slots of the commutator 12 assembly to provide a smooth, continuous external surface for motor brushes 18 to act against. Filler material 32 reduces brush vibration and arcing, which results in the lowered audible noise and RFI emissions of motor 10 or other similar device to which the filler is applied. One example of a filler material 32 suitable for this application is EL852, a two-part epoxy available from Jiaxing Enail Electrical Materials Co. LTD. E1852 is composed of a part epoxy resin and filler, and a part curing agent, accelerant, and filler. The segmented commutator 12 includes slots 34 between segments 36 to provide the electrical insulation between consecutive sets of windings as the motor rotates. Insulating filler material 32 is added to slots 34 to provide a continuous outer surface of the commutator.

Also shown in FIG. 1, motor 10 includes an outer housing 38, usually consisting of a cylindrical steel shell. A thrust washer 40 is provided for armature 22, which may be of either flat or wave spring design. The main shaft 17 of the motor 10 provides the central core support for the armature components and functions as the mechanical output member of motor 10. A brush holder 42 guides and locates a brush 18 against commutator 12. Some alternative designs eliminate this component and attach the brush directly to the brush spring element.

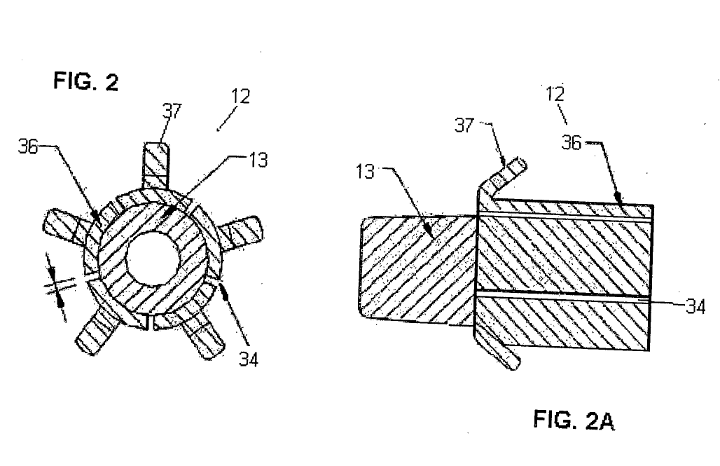

FIG. 2 shows the typical segmented commutator 12 with open, unfilled slots 34 between segments 36 to provide the electrical isolation between the windings for each motor pole. The main body 13 of the commutator 12 assembly is typically formed from an insulating material such as plastic. The conductive commutator segment 36 is usually of copper or brass material, bonded or molded securely to the insulating commutator core 13, typically during the core molding process. A retaining hook 37 that is part of the conductive segment 36 is used to retain and make electrical contact with the windings of the commutator 12.

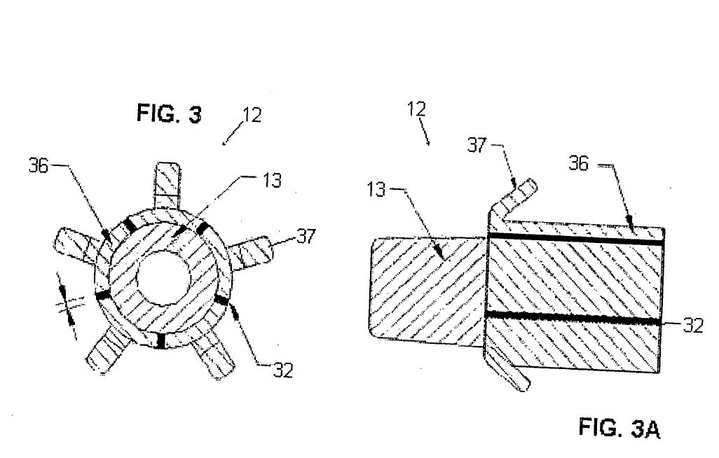

FIG. 3 shows the same segmented commutator 12 as described with reference to FIG. 2, except slots 34 between commutator segments are shown filled with the insulating material 32 which is the improvement described in this patent. This filler, the dark region indicated at 32, provides the continuous commutator surface that eliminates the harsh interaction of the brushes 18 with the leading edges of the commutator segments 36 as commutator 12 turns within motor 10.

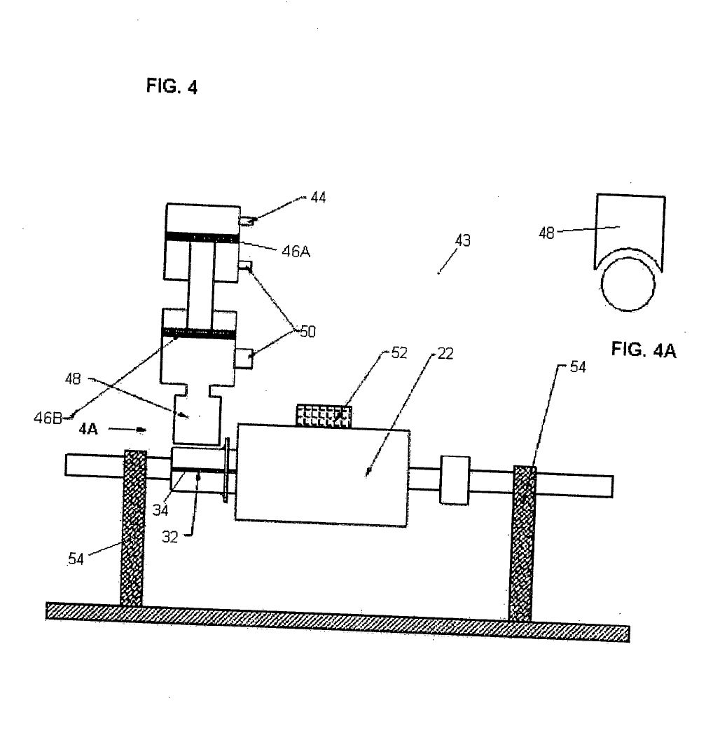

FIGS. 4 and 5 illustrate two different manufacturing processes that could be used to fill slots 34 of a segmented commutator 12 with an insulating material 32.

FIG. 4 is a schematic of a system generally designated 43 for a rotational manufacturing process to fill the commutator 12 slots 34. In this process a pneumatic cylinder 44 provides the force to push the insulating filler material 32 into the commutator slots 34 as the armature 22 is rotated. Pistons 46 of system 43, the upper piston 46A provides the force from pneumatic pressure, and the lower piston 46B presses the filler material into the slots of the commutator. Any known drive system that can pressurize the filler material could be used in place of the pneumatic system shown. An outlet nozzle 48 guides the insulating filler material 32 against the exterior surface of the commutator 12 and into the slots 34 between the segments 36 as the armature 22 is rotated. An inlet 50 through which the filler material 32 is continually introduced to fill slots 34 between the segments 36 of commutator 12 in this process. A drive mechanism 52 to rotate armature 22 is typically a drive belt or drive wheel with friction contact to the outside diameter of the armature 22. Armature 22 is supported in racks 54 which preferably are V-shaped, or otherwise shaped to correctly position commutator 12 for filling of slots 34 and allow commutator rotation by drive mechanism 52.

FIG. 5 is a schematic showing a typical extrusion-type manufacturing process assembly 56 that could be used for filling the commutator slots 34. In this process, commutator 12 is inserted into a tight fitting sleeve and the insulating filler material 32 is forced under pressure into the slots 34 between commutator segments 36. The extruding force in this example is provided by a pneumatic piston system, although other methods of providing force could be utilized. Armature 22 is supported by a fixture 58 so that the commutator 12, can be inserted into a tight fitting sleeve of the extrusion device. The insulating filler material 32 is disposed in an accumulation and pressure chamber 60, from which it is then pressure fed into the commutator slots 34. Filler material 32 is added through an inlet 62 and pressurized by a piston 64. Inlet 66 and outlet 68 ports for the pneumatic force system are also provided, for example, as illustrated.

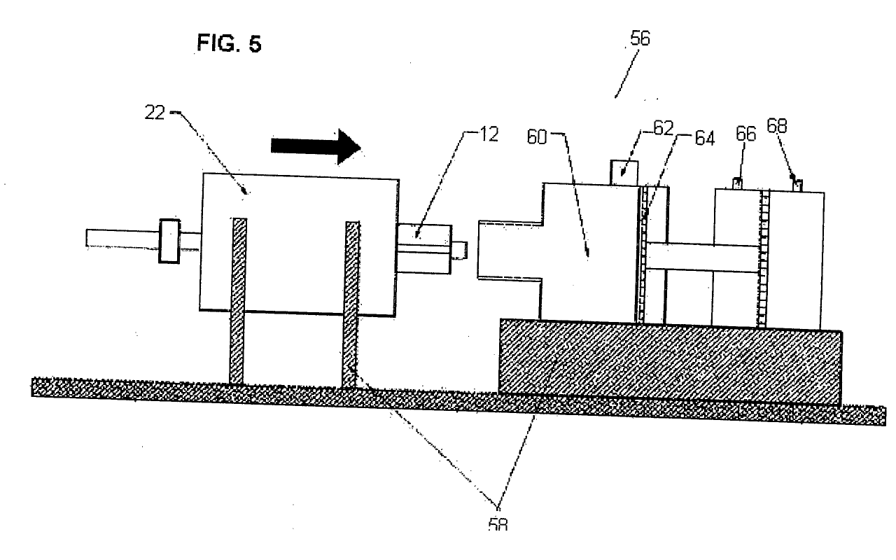

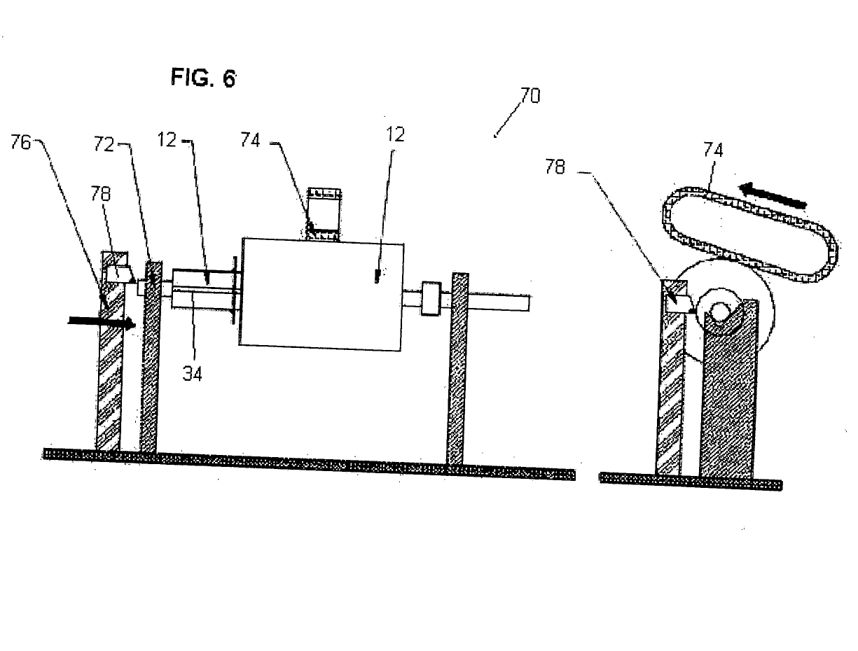

FIG. 6 shows a typical machining process assembly 70 used to ensure that the commutator 12 surface is concentric with the armature shaft 17, and to provide a smooth outer surface on the commutator segments 36. Armature assembly 22 is supported by its shaft ends in a V-block fixture 72, which allows armature 22 to rotate about its shaft axis when driven by a friction drive belt or transmission strap 74. A cutting tool holder device 76 moves parallel to the armature shaft axis so that the cutting tool 78 can lightly contact the commutator surface 12 and remove a small amount of material from the surface of the commutator. This ensures the concentricity of the commutator surface to the shaft, and provides a smooth surface on the commutator segments 36. For higher precision motors and lowest operating noise, multiple passes of the cutting tool 78 over the commutator surface may be employed with finer cuts to remove less material and produce a more highly finished surface. A final polishing step may be utilized with a polishing wheel or device substituting for the cutting tool. When the commutator slots 34 have been filled with an insulating material for noise and RFI improvement, the machining operations normally used to process the surface of the commutator 12 do not change. The filler material 32 is simply removed along with the commutator segment material by the action of the cutting tool 78, and the finished commutator then has a smooth, continuous outer surface for the brushes to press against with no slot 34 leading edges to produce noise and vibration.

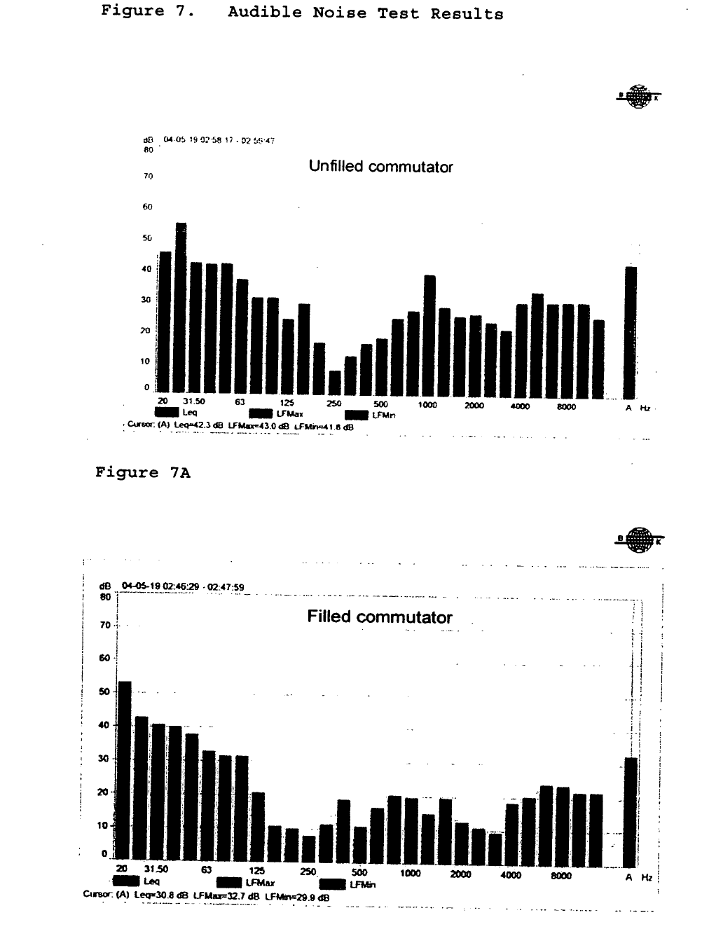

FIGS. 7 and 7A show the results of noise testing on two D.C. motors, which are identical except for their commutator slots. A standard motor with typical unfilled commutator slots (shown in FIG. 7) is compared to the same design motor with the slots filled with an insulating material (FIG. 7A). The decibel level of both motors is displayed across the audible spectrum, and the noise level advantage of the filled slot commutator can be seen. In the example shown, the filled commutator reduced overall motor noise level from 43.0 dB to 32.7 dB.

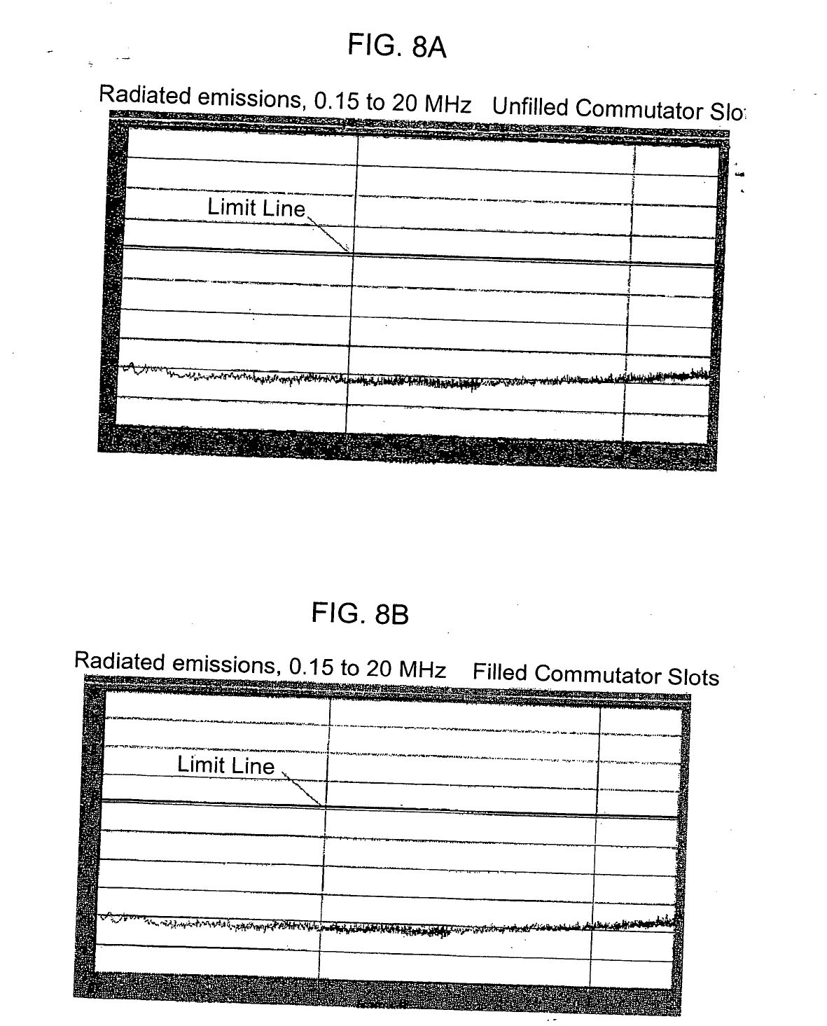

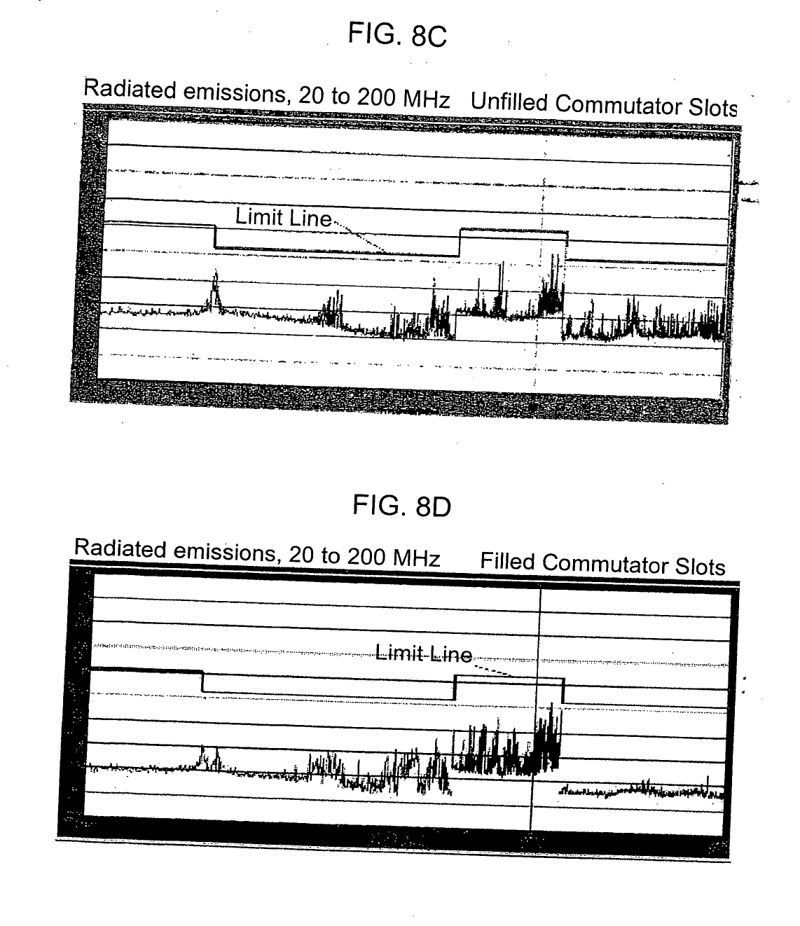

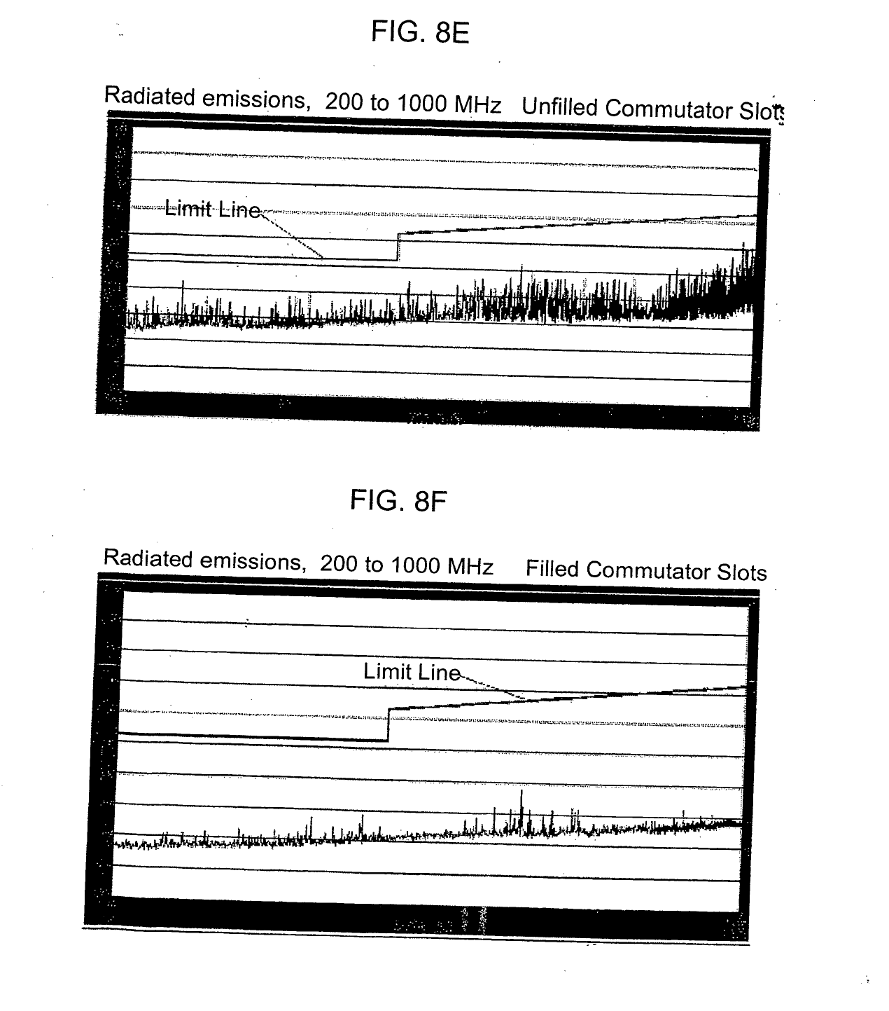

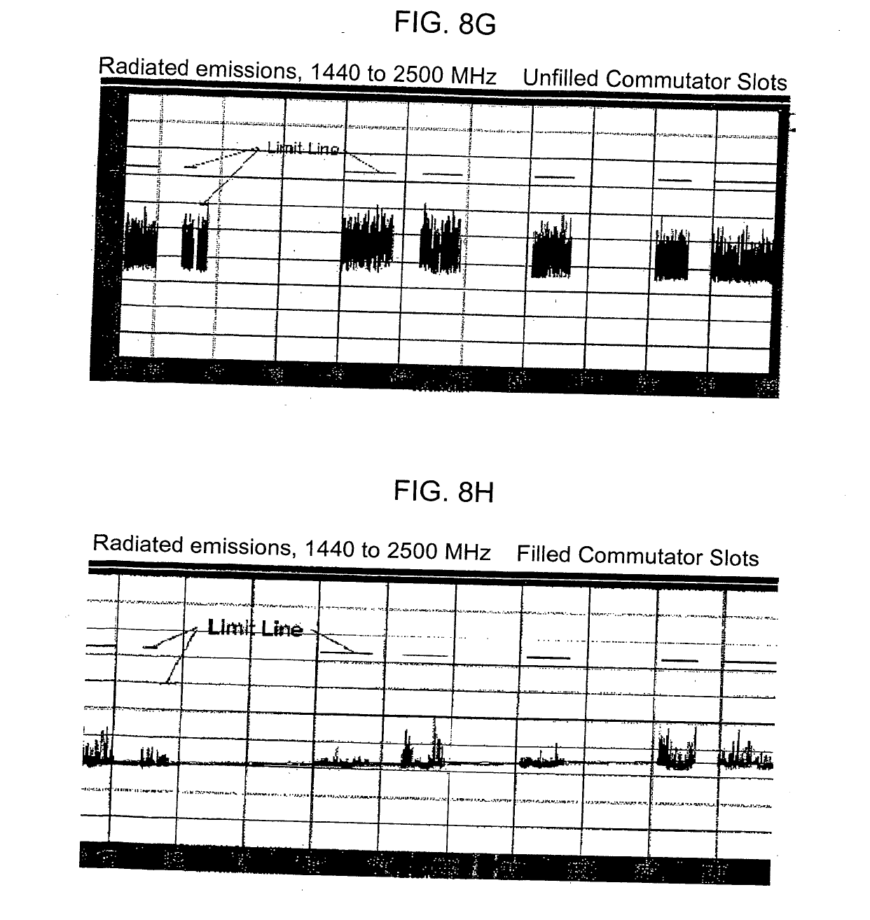

FIG. 8 shows RFI test results on two D.C. motors, which are identical except for their commutator slots. The graphs 8A,8C, 8E, and 8G, show motor emission field strength in units of dBuVA/M across four frequency ranges—0.015 to 20 MHz, 20 to 200 MHz, 200 to 1000 Mhz, and 1440 to 2500 Mhz, respectively. A standard motor with typical unfilled commutator slots is compared to the same design motor with the slots filled with an insulating material in graphs 8B, 8D, 8F, 8H. Both motors were tested for radiated emissions per the requirements of GMW 3100 with the limit line indicated for each frequency range. The comparison in FIG. 8 shows the quieting effect of the filled commutator on motor noise emissions, especially at the higher radio frequencies.

In view of the foregoing, it will be seen that the several objects of the invention are achieved and other advantages are attained.

Although the foregoing includes a description of the best mode contemplated for carrying out the invention, various modifications are contemplated. As various modifications could be made in the constructions and methods herein described and illustrated without departing from the scope of the invention, it is intended that all matter contained in the foregoing description or shown in the accompanying drawings shall be interpreted as illustrative rather than limiting.

What is claimed is:

1. A method of reducing the audible operating noise of an electric power conversion device comprising providing a segmented commutator with slots between the segments and smoothing the brush transition between the slots to reduce brush vibration and the associated noise ordinarily created when the motor brush contacts the commutator.

2. The method of claim 1 and further comprising placing an insulating filler material in the commutator slots to thereby provide the smooth brush transition between commutator segments.

3. The method of claim 2 and further comprising providing the insulating filler material as a two-part epoxy.

4. A method of reducing the RFI electronic operating noise of an electric power conversion device comprising providing a segmented commutator with slots between the segments and smoothing the brush transition between the slots to reduce brush vibration and the associated electrical arcing.

5. The method of claim 4 and further comprising placing an insulating filler material in the commutator slots to thereby provide the smooth brush transition between commutator segments.

6. The method of claim 5 and further comprising providing the insulating filler material as a two-part epoxy.

7. The process of claim 2 and further comprising filling the commutator slots of power conversion devices with segmented commutators of electric motors.

8. The process of claim 7 and further comprising manually applying an insulating filler material to the slots of a segmented commutator using simple hand tools.

9. The process of claim 7 and further comprising applying a filler material to the slots of a segmented commutator by applying pressure to the filler material and thereby extruding the filler material into the slots of a commutator tightly confined on an outside diameter of the commutator.

10. The process of claim 7 and further comprising applying an insulating filler material to the slots of a segmented commutator by applying pressure to the filler material and forcing the insulating filler material into the slots of a rotating commutator through a nozzle shaped to fit the commutator outer contour.

11. The process of claim 2 and further comprising cutting commutator segments in the same operation to the same outer diameter to provide a smooth, continuous, surface for the brushes to act against.

12. The process of claim 4, and further comprising cutting commutator segments in the same operation to the same outer diameter to provide a smooth, continuous surface for the brushes to act against.

13. The process of claim 11, and further comprising making multiple cuts and polishing the filled commutator to achieve a more highly improved surface finish and concentricity and thereby further reducing the audible noise of the device.

14. The process of claim 12, and further comprising making multiple cuts and polishing the filled commutator to achieve a more highly improved surface finish and concentricity and thereby further reducing the RFI electronic operating noise of the device.

15. A noise reduced electric power conversion device comprising a commutator having segments separated by slots spaced around the external surface of the commutator, wherein the slots are filled with an insulating material to thereby provide a smooth brush transition between the slots and brush of a motor during electric power conversion.

16. An electric motor having a noise reduced electric power conversion device, wherein the device comprises a commutator having segments separated by slots spaced around the external surface of the commutator, wherein the slots are filled with an insulating material to thereby provide a smooth brush transition between the slots and brush of a motor during electric power conversion.

17. An assembly for producing a noise reduced electric power conversion device, the assembly comprising a tight sleeve sized and shaped appropriately for receiving a commutator, the commutator having slots between segments on the outer surface of the commutator, and an extruder to force insulating filler material under pressure into the slots of the commutator.

18. The assembly of claim 17, and further comprising a piston mechanism to thereby apply force, a fixture, an armature supported by the fixture so that the commutator can be inserted into the sleeve of the extrusion device, and an accumulation and pressure chamber for the insulating filler material to thereby provide pressurized feed into the commutator slots.

19. An assembly for producing a noise reduced electric power conversion device, the assembly comprising a machining device having a cutting tool disposed in movable contact with the surface of a commutator having insulating material filled slots when an armature with such commutator is supported on the assembly, a drive device and a V-block fixture to support the armature assembly by shaft ends of the armature assembly and allow the armature to rotate about its shaft axis when driven by the drive device, the cutting tool being movable parallel to the armature shaft axis so that the cutting tool lightly contacts the commutator to remove material and provide a smooth surface on the commutator segments, to thereby produce high precision motors with low operating noise relative to conventional motors without filled commutator slots.
